(19) United States
(12) Patent Application Publication
(10) Pub. No.: US 2015/0352738 A1
(43) Pub. Date: Dec. 10, 2015

(54) CROSS AXE

(71) Applicant: Christopher James Gregg, Newport Richey, FL (US)

(72) Inventor: Christopher James Gregg, Newport Richey, FL (US)

(21) Appl. No.: 14/299,899

(22) Filed: Jun. 9, 2014

(51) Int. Cl. B26B 23/00

(52) U.S. Cl. CPC B26B 23/00

(57) ABSTRACT

A cross axe adapted for manual use to split wood logs has an elongated handle having a gripping section at one end and an axe head mounting section at another end with a cross axe head mounted fixedly thereon, The cross axe head having a pair of transverse blades presenting a cross shape as viewed from the front or rear.

### FIELD OF THE INVENTION

The present invention relates to an axe for splitting wood. More particularly, a preferred embodiment of the present invention relates to an axe having multiple blades for manually splitting wood into quarter sections.

### BACKGROUND OF THE INVENTION

Axes and wedges have been used for many years to split logs into smaller pieces suitable for use as firewood in fireplaces, stoves, campfires or the like. Devices and apparatus of many designs are in use for splitting of wood and particularly, logs. However, users of these devices still encounter several issues. For example, many users are limited to use of manual axes or wedges and cannot use more sophisticated powered log splitters. Manual axes or wedges are subject to becoming jammed in the log if it is not hit with sufficient force to split it. A conventional ax or wedge only provides two pieces per strike and many strikes may be required to obtain a sufficient number of pieces of firewood. Also, some axes transmit a shockwave through the handle which can cause the handle to break and/or cause stress to the user's hand, wrist and arms.

Thus, there remains a need for an improved axe which can be used manually to split wood in an efficient manner and which can be comfortably used to split wood into more than two pieces per strike. Accordingly, the present invention provides a cross axe which can be comfortably used to manually split wood into four pieces. The design features of preferred embodiments of the present invention provide efficient use of force to split wood.

Further understanding of the present invention will be had from the following description and claims taken in conjunction with the accompanying drawings.

### BRIEF DESCRIPTION OF THE DRAWINGS

FIG. 1 is a side elevation view of a preferred embodiment of a cross axe of the present invention;

FIG. 2 is a front perspective view of the cross axe of FIG. 1 with its handle broken away;

FIG. 3 is rear perspective view of the cross axe of FIGS. 1-2 with its handle broken away;

FIG. 4 is a top plan view of the cross axe of FIGS. 1-3;

FIG. 5 is a rear elevation view of the cross axe of FIGS. 1-4 with its handle broken away;

FIG. 6 is a front elevation view of the cross axe of FIGS. 1-5 with its handle broken away; and

FIG. 7 is a side elevation view of the cross axe of FIGS. 1-6 with its handle broken away.

### SUMMARY OF THE INVENTION

A cross axe adapted for manual use to split wood logs has an elongated handle having a gripping section at one end and an axe head mounting section at another end with a cross axe head mounted fixedly thereon, The cross axe head has a pair of transverse cutting blades transversely oriented to present a cross shape as viewed from the front. Each of the blades of the cross axe has a relatively thin forward facing cutting edge and a relatively thick rearward facing flat surface, with symmetrical ramps between the forward facing cutting edges and the rearward facing flat surface. The ramps are curvilinear to maximize their effectiveness to split wood logs and the blades are preferably formed in a unitary, one piece manner by casting or the like. The cross axe head and handle are designed and constructed to minimize vibration imparted to the user when splitting wood logs.

### DESCRIPTION OF THE INVENTION

A preferred embodiment of the present invention relates to a cross axe for use in splitting wood logs or the like. The cross axe has a cross axe head mounted on a handle and can be manually used by an operator to split wood for a fireplace, wood stove, fire pit, or other suitable fire container. The cross axe head can be relatively small for splitting kindling or can be relatively larger for splitting larger logs.

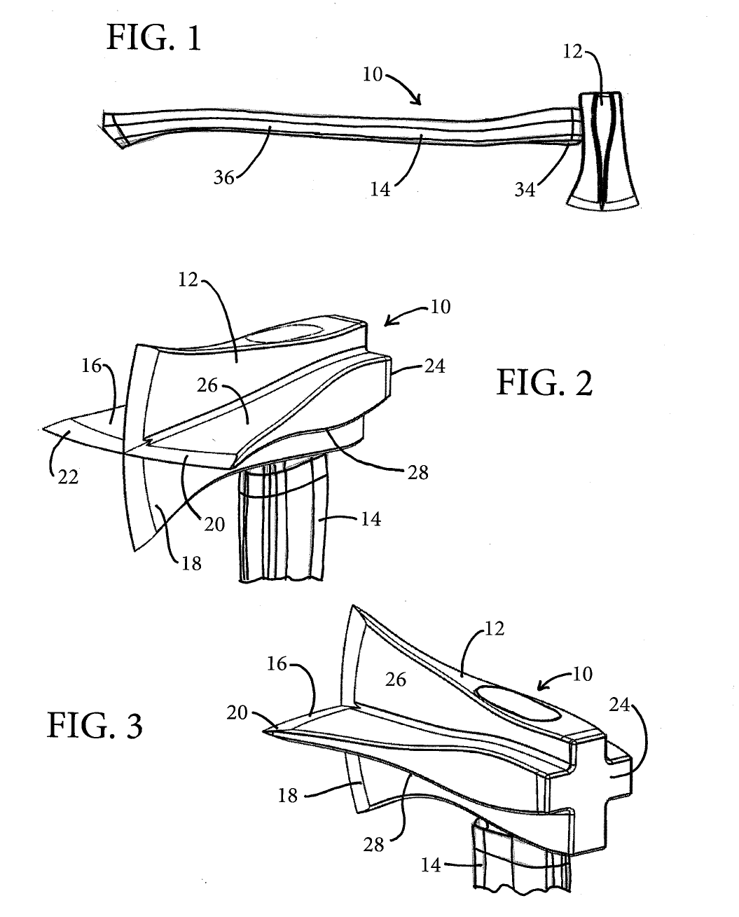

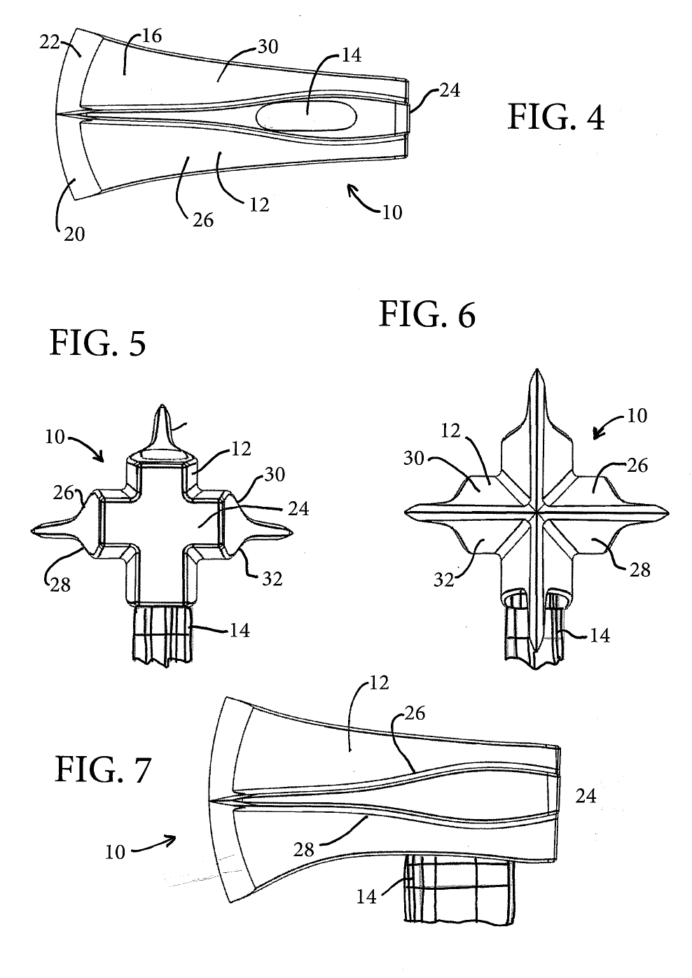

Now referring to FIGS. 1 to 7, a preferred embodiment of the present invention is shown and indicated generally by the numeral 10. Broadly speaking, cross axe 10 comprises cross axe head 12 mounted on elongated handle 14.

Cross axe head 12 has a pair of somewhat flat blades, 16 and 18, which are medially joined and positioned generally transverse to each other. Preferably blades 16 and 18 are formed of steel or equivalent material and are of a one-piece cast construction. The forward end of blade 16 presents a thin left cutting edge 20 and a thin right cutting edge 22. The rearward end of blade 16 joins rearward facing flat 24 which is common with the rearward end of blade 18. Upper and lower curvilinear ramps 26 and 28 extend between left cutting edge 20 and rearward facing flat 24. Similarly, upper and lower curvilinear ramps 30 and 32 extend between thin right cutting edge 22 and rearward facing flat 24. Blade 18 is of analogous construction to blade 16 but is oriented transversely to blade 16. Rearward facing flat 24 is adapted to be driven with a maul or hammer if desired.

Blades 16 and 18 are preferably polished and coated with a hard, slick material such as titanium nitride to reduce friction between the blades and wood being split as well as to protect the blades from rust or corrosion.

Cross axe head 12 is mounted securely on one end section 34 of elongated handle 14 by any suitable means. The other end section 36 of handle 14 is adapted for gripping by the user or operator of cross axe 10 in splitting wood. The angle of attachment of head 12 to handle 14 should be set to minimize shock wave/vibration imparted to handle 14 when head 12 contacts wood during use of cross axe 10.

In operation, section 36 of handle 14 is grasped securely by an operator and then cross axe 10 is swung in a conventional manner to strike the end of a wood log to be split. Blades 16 and 18 provide approximately twice as much mass as a conventional single blade ax and hence the momentum of the wood strike is substantially greater than that of a conventional axe. Cross axe 10 is effective to split logs into quarters, i.e., four pieces, instead of halves or only two pieces as result from a conventional axe with a single blade. Thus, more pieces of wood can be provided for a given amount of swings with a cross axe of the present invention resulting in increased productivity and/or a shortened time required for a given number of logs split.

It will be appreciated by those skilled in the art that the present invention is subject to modification and variation. For example, cross axe head 12 can be of any selected size suitable for its intended purpose of splitting kindling or larger logs. It is intended that such modifications and variations are considered to be within the broad scope of the invention which is intended to be limited only by the following claims.

What is claimed is:

1. A cross axe adapted for manual use to split wood logs comprising:
an elongated handle having a gripping section at one end and an axe head mounting section at another end,
a cross axe head mounted on said mounting section of said handle, said cross axe head having a pair of transverse blades, each of said blades having a relatively thin forward facing cutting edge and a relatively thick rearward facing flat surface, each of said blades defining a pair of symmetrical ramps from said cutting edge to said flat surface.

2. A cross axe as in claim 1 wherein said rearward facing flat surfaces form a cross shape.

3. A cross axe as in claim 2 wherein said forward facing cutting edges form a cross shape.

4. A cross axe as in claim 3 wherein said ramps are curvilinear.

5. A cross axe as in claim 4 wherein said blades are formed in a unitary manner.

6. A cross axe as in claim 5 wherein said blades are congruent with a midpoint between said forward facing cutting edges and said rearward facing flat surface and said handle is mounted aft of the midpoint of said blades.
